(19) United States
(12) Patent Application Publication
(10) Pub. No.: US 2021/0327238 A1
(43) Pub. Date: Oct. 21, 2021

(54) Fire Safety Assembly

(71) Applicant: Tommy Ward, Huntsville, AL (US)

(72) Inventor: Tommy Ward, Huntsville, AL (US)

(21) Appl. No.: 16/848,993

(22) Filed: Apr. 15, 2020

(51) Int. Cl. G08B 17/10; G08B 21/12; H02H 3/02; F23N 5/24; H01R 31/06; H01R 13/66; H02H 1/00

(52) U.S. Cl. CPC G08B 17/10; G08B 21/12; H02H 3/02; H02H 1/0007; H01R 31/065; H01R 13/6683; F23N 5/242

(57) ABSTRACT

A fire safety assembly includes a power supply that is pluggable into a female electrical outlet to receive electrical current from the female electrical outlet. A shut off circuit is integrated into the power supply and the shut off circuit turns off the power supply when the shut off circuit receives an alert input. A smoke detector is integrated into the power supply to detect smoke. A carbon monoxide sensor is integrated into the power supply to sense carbon monoxide. A temperature sensor is integrated into the power supply and the temperature sensor is in thermal communication with the power supply. The shut off circuit turns off the power supply when the smoke detector detects smoke, the carbon monoxide sensor senses carbon monoxide or the temperature sensor senses excessive heat.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fire safety devices and more particularly pertains to a new fire safety device for turning off power to an electronic device when smoke, carbon monoxide or excessive temperatures are detected.

### (2) Description of Related Art Including Information Disclosed Under 37 CFR 1.97 and 1.98

The prior art relates to fire safety devices. The prior art discloses an electrical outlet that includes a smoke detector and a moisture level of a Christmas tree for safeguarding against a fire. The prior art discloses a power source that includes a gas sensor for shutting off when a gas leak is detected. The prior art discloses an appliance shut off device that sends a shut down signal to appliances when an audible smoke alarm is detected. The prior art also discloses a power outlet that is synchronized with a smoke detector for turning off electrical power when smoke is detected. The prior art discloses a power strip that has a hazard detector for shutting off electrical power during a hazard. The prior art also discloses an electrical outlet that includes a temperature sensor for turning off an appliance when excessive heat is detected.

### BRIEF SUMMARY OF THE INVENTION

An embodiment of the disclosure meets the needs presented above by generally comprising a power supply that is pluggable into a female electrical outlet to receive electrical current from the female electrical outlet. A shut off circuit is integrated into the power supply and the shut off circuit turns off the power supply when the shut off circuit receives an alert input. A smoke detector is integrated into the power supply to detect smoke. A carbon monoxide sensor is integrated into the power supply to sense carbon monoxide. A temperature sensor is integrated into the power supply and the temperature sensor is in thermal communication with the power supply. The shut off circuit turns off the power supply when the smoke detector detects smoke, the carbon monoxide sensor senses carbon monoxide or the temperature sensor senses excessive heat.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a fire safety assembly according to an embodiment of the disclosure for a 120.0 volt circuit.

FIG. 2 is a back perspective view of an embodiment of the disclosure for a 120.0 volt circuit.

FIG. 3 is a right side view of an embodiment of the disclosure for a 120.0 volt circuit.

FIG. 4 is a schematic view of an embodiment of the disclosure for a 120.0 volt circuit.

FIG. 5 is a front perspective view of an embodiment of the disclosure for a 220.0 volt circuit.

FIG. 6 is a right side view of an embodiment of the disclosure for a 220.0 volt circuit.

FIG. 7 is a schematic view of an embodiment of the disclosure for a 220.0 volt circuit.

### DETAILED DESCRIPTION OF THE INVENTION

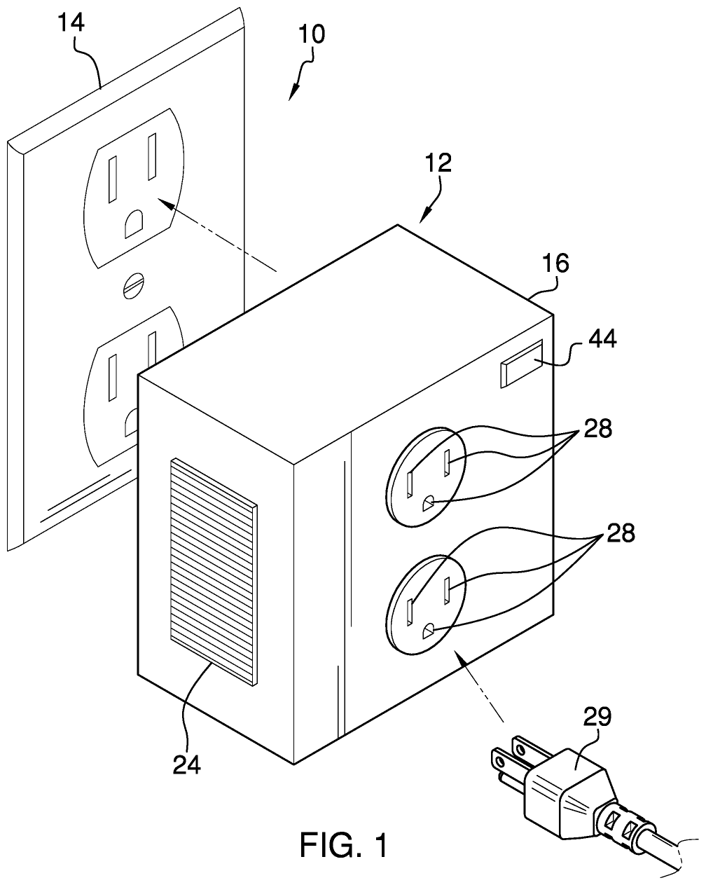

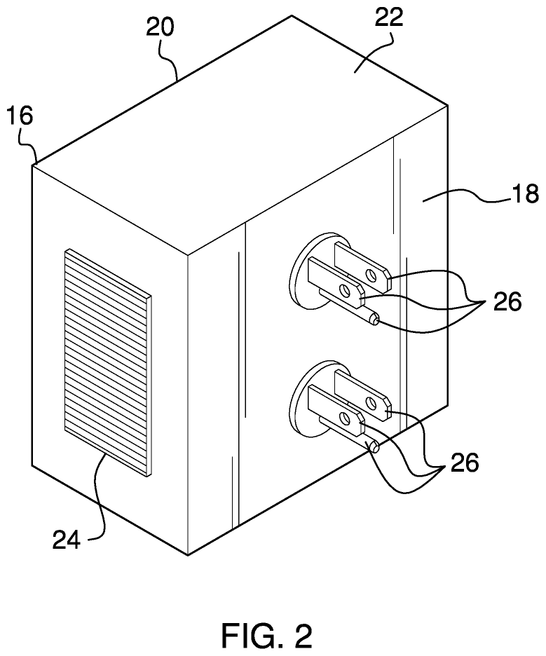

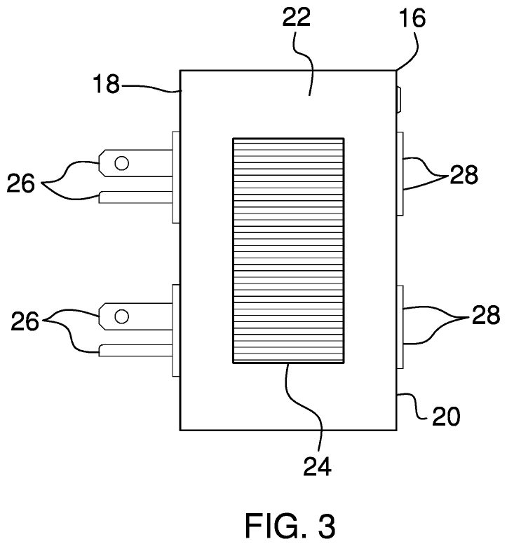

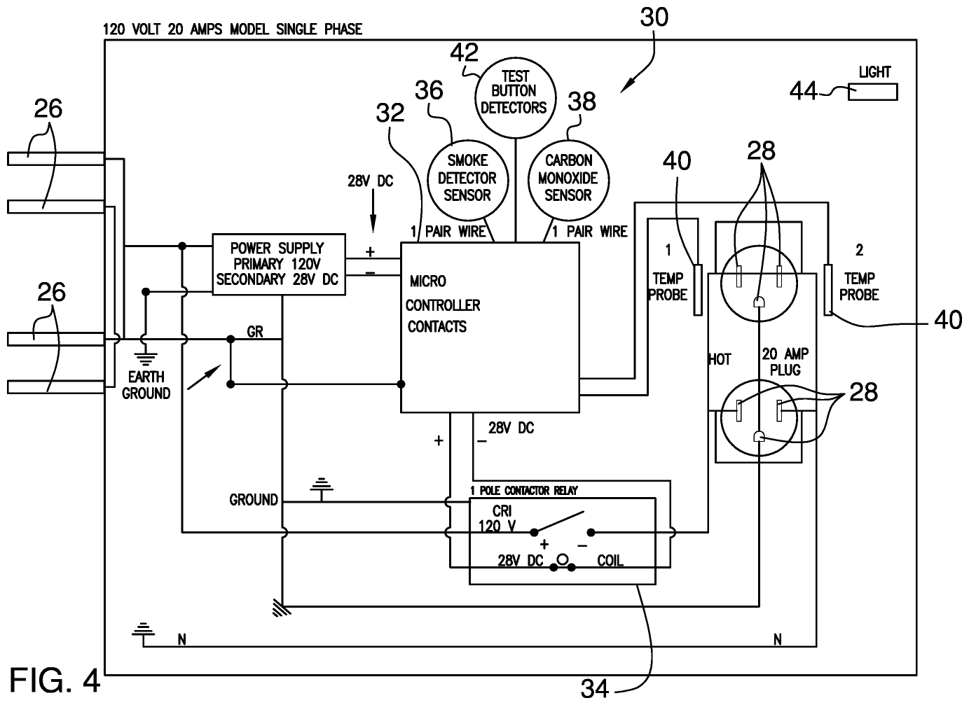

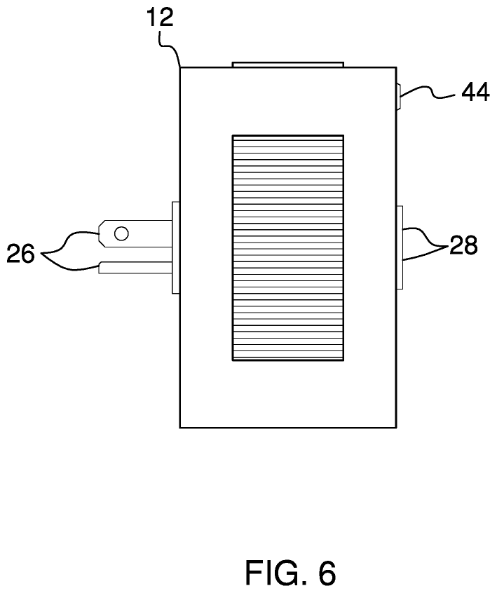

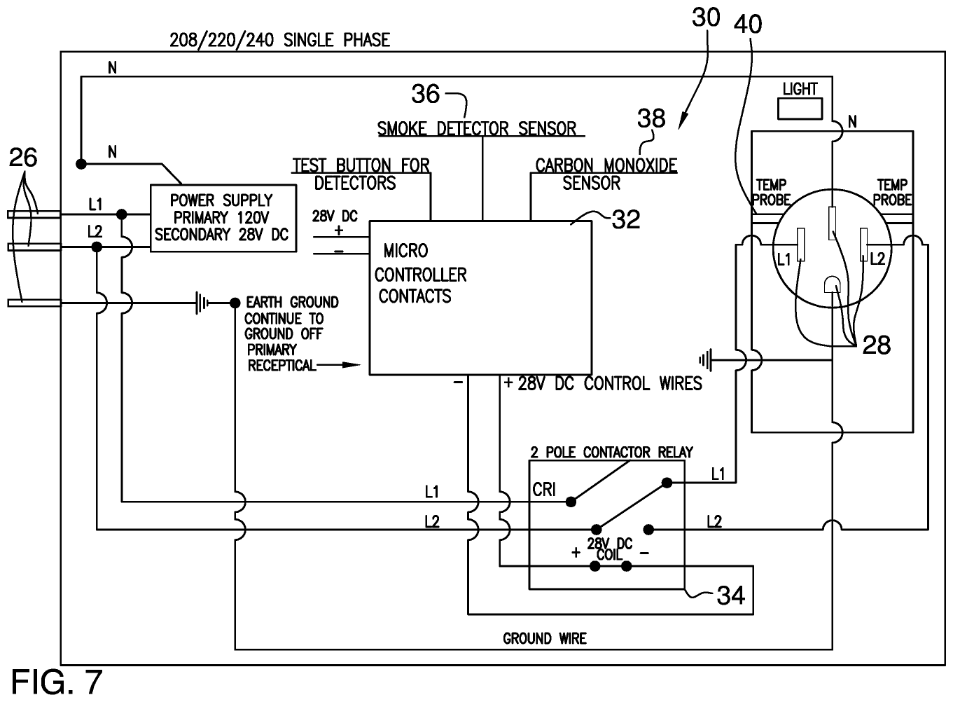

With reference now to the drawings, and in particular to FIGS. 1 through 7 thereof, a new fire safety device embodying the principles and concepts of an embodiment of the disclosure and generally designated by the reference numeral 10 will be described.

As best illustrated in FIGS. 1 through 7, the fire safety assembly 10 generally comprises a power supply 12 that is pluggable into a female electrical outlet 14 to receive electrical current from the female electrical outlet 14. The female electrical outlet 14 may be an electrical outlet in a house or the like that conforms to National Electrical Code for building construction. The power supply 12 comprises a housing 16 that as a rear wall 18, a front wall 20 and an outer wall 22 extending therebetween. The outer wall 22 has a vent 24 extending into an interior of the housing 16 to pass air into the housing 16. The housing 16 may have a height and a width ranging between approximately 4.0 inches and 6.0 inches.

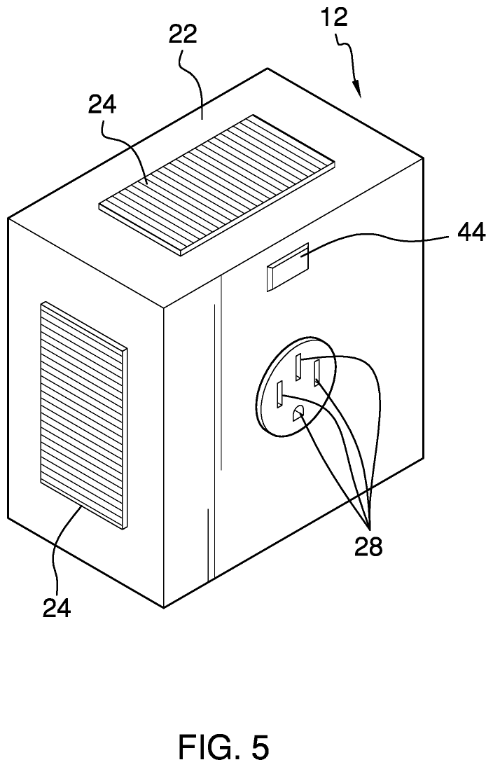

A plurality of male contacts 26 is each coupled to and extends away from the rear wall 18 of the housing 16. Each of the male contacts 26 is comprised of an electrically conductive material and each of the male contacts 26 is pluggable into the female electrical outlet 14. A plurality of female contacts 28 is each recessed into the front wall 20 of the housing 16 to receive a power cord 29 of an electrical device. As is most clearly shown in FIGS. 1 through 4, each of the male contacts 26 and each of the female contacts 28 may be structured to accommodate a conventional three prong A/C circuit as is commonly employed in the United States. As is most clearly shown in FIGS. 5 through 7, each of the male contacts 26 and the female contacts 28 may be structured to accommodate a conventional three prong A/C circuit as is commonly employed in Europe.

A shut off circuit 30 is provided and the shut off circuit 30 is integrated into the power supply 12. The shut off circuit 30 turns off the power supply 12 when the shut off circuit 30 receives an alert input. The shut off circuit 30 comprises a control circuit 32 that is integrated into the power supply 12. The control circuit 32 is electrically coupled to each of the male contacts 26 and each of the female contacts 28. The control circuit 32 receives a smoke input, a carbon monoxide input and a temperature input.

The shut off circuit 30 includes a contact relay 34 that is positioned within the housing 16. The contact relay 34 is electrically coupled to the control circuit 32. The contact relay 34 is electrically coupled between each of the male contacts 26 and each of the female contacts 28. The contact relay 34 is actuated into a shut off condition when the control circuit 32 receives any of the smoke input, the carbon monoxide input or the temperature input. In this way the contact relay 34 inhibits electrical current from passing between the male contacts 26 and the female contacts 28. The contact relay 34 is actuated into a turn on condition when the control circuit 32 does not receive any of the smoke input, the carbon monoxide input or the temperature input. In this way the contact relay 34 passes electrical current between the male contacts 26 and the female contacts 28.

A smoke detector 36 is integrated into the power supply 12 to detect smoke. The shut off circuit 30 receives the alert input when the smoke detector 36 detects smoke to inhibit an electrical fire from starting. The smoke detector 36 is in fluid communication with the vent 24 in outer wall 22 of the housing 16 and the smoke detector 36 is electrically coupled to the control circuit 32. Moreover, the control circuit 32 receives the smoke input when the smoke detector 36 detects smoke. The smoke detector 36 may be an electronic smoke detector of any conventional design.

A carbon monoxide sensor 38 is integrated into the power supply 12 to sense carbon monoxide. The shut off circuit 30 receives the alert input when the carbon monoxide sensor 38 senses carbon monoxide to inhibit an electrical fire from starting. The carbon monoxide sensor 38 is in fluid communication with the vent 24 in the outer wall 22 of the housing 16 and the carbon monoxide sensor 38 is electrically coupled to the control circuit 32. Moreover, the control circuit 32 receives the carbon monoxide input when the carbon monoxide sensor 38 senses carbon monoxide.

A temperature sensor 40 is integrated into the power supply 12 and the temperature sensor 40 is in thermal communication with the power supply 12. The shut off circuit 30 receives the alert input when the temperature sensor 40 senses that the power supply 12 has exceeded a pre-determined temperature. In this way the power supply 12 may inhibit an electrical fire from starting. The temperature sensor 40 is in thermal communication with each of the female contacts 28 in the housing 16 and the temperature sensor 40 is electrically coupled to the control circuit 32. The control circuit 32 receives the temperature input when the temperature sensor 40 senses that any of the female electrical contacts exceeds the pre-determined temperature. Additionally, the temperature sensor 40 may comprise an electronic temperature sensor 40 of any conventional design and the pre-determined temperature may be a temperature at or above 120.0 degrees Fahrenheit.

A test button 42 is provided and the test button 42 is movably coupled to the power supply 12. The test button 42 is electrically coupled to the control circuit 32 and the contact relay 34 is turned off when the test button 42 is depressed. A light emitter 44 is coupled to the power supply 12 to emit light outwardly therefrom and the light emitter 44 is electrically coupled to the control circuit 32. The light emitter 44 is turned on when the contact relay 34 is actuated into the turn on condition to visually communicate that each of the female contacts 28 has electrical current is supplied thereto.

In use, the power supply 12 is plugged into the female electrical outlet 14 and the electronic device is plugged into the power supply 12. The power supply 12 is turned off in the event 24 that smoke is detected, carbon monoxide is detected or excessive temperatures are detected. In this way the power supply 12 reduces the likelihood that an electrical fire will develop. Moreover, the power supply 12 reduces the likelihood that occupants of the building will perish due to fire.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A fire safety assembly for plugging into an electrical outlet and severing electrical service when heat or smoke being detected for inhibiting a fire from developing, said assembly comprising:
a power supply being pluggable into a female electrical outlet wherein said power supply being configured to receive electrical current from the female electrical outlet, said power supply comprising a housing having a rear wall, a front wall and an outer wall extending between said rear wall and said front wall, said outer wall having a pair of vents extending into an interior of said housing on opposing sides of said housing wherein each vent is perpendicular to said rear wall and is thereby configured to be positioned perpendicular to the female electrical outlet to pass air into and through said housing;
a shut off circuit being integrated into said power supply, said shut off circuit turning off said power supply when said shut off circuit receives an alert input;
a smoke detector being integrated into said power supply wherein said smoke detector being configured to detect smoke, said shut off circuit receiving said alert input when said smoke detector detects smoke wherein said power supply being configured to inhibit an electrical fire from starting;
a carbon monoxide sensor being integrated into said power supply wherein said carbon monoxide sensor being configured to sense carbon monoxide, said shut off circuit receiving said alert input when said carbon monoxide sensor senses carbon monoxide wherein said power supply being configured to inhibit an electrical fire from starting; and
a temperature sensor being integrated into said power supply, said temperature sensor being in thermal communication with said power supply, said shut off circuit receiving said alert input when said temperature sensor senses that said power supply has exceeded a pre-determined temperature wherein said power supply being configured to inhibit an electrical fire from starting.

2. (canceled)

3. The assembly according to claim 1, wherein said power supply includes a plurality of male contacts, each of said male contacts being coupled to and extending away from said rear wall of said housing, each of said male contacts being comprises of an electrically conductive material, each of said male contacts being pluggable into the female electrical outlet.

4. The assembly according to claim 1, wherein said power supply includes a plurality of female contacts, each of said female contacts being recessed into said front wall of said housing wherein each of said female contacts being configured to receive a power cord of an electrical device.

5. The assembly according to claim 1, wherein:
said power supply includes a plurality of male contacts and a plurality of female contacts; and
said shut off circuit comprises a control circuit being integrated into said power supply, said control circuit being electrically coupled to each of said male contacts and each of said female contacts, said control circuit receiving a smoke input, said control circuit receiving a carbon monoxide input, said control circuit receiving a temperature input.

6. The assembly according to claim 5, wherein said power supply includes a contact relay being positioned within said housing, said contact relay being electrically coupled to said control circuit, said contact relay being electrically coupled between each of said male contacts and each of said female contacts.

7. The assembly according to claim 6, wherein:
said contact relay being actuated into a shut off condition when said control circuit receives any of said smoke input, said carbon monoxide input Or said temperature input wherein said contact relay being configured to inhibit electrical current from passing between said male contacts and said female contacts; and
said contact relay being actuated into a turn on condition when said control circuit does not receive any of said smoke input, said carbon monoxide input or said temperature input wherein said contact relay being configured to pass electrical current between said male contacts and said female contacts.

8. The assembly according to claim 1, wherein said smoke detector being in fluid communication with said vent in outer wall of said housing.

9. The assembly according to claim 5, wherein said smoke detector being electrically coupled to said control circuit, said control circuit receiving said smoke input when said smoke detector detects smoke.

10. The assembly according to claim 1, wherein said carbon monoxide sensor being in fluid communication with said vent in said outer wall of said housing.

11. The assembly according to claim 5, wherein said carbon monoxide sensor being electrically coupled to said control circuit, said control circuit receiving said carbon monoxide input when said carbon monoxide sensor senses carbon monoxide.

12. The assembly according to claim 4, wherein said temperature sensor being in thermal communication with each of said female contacts in said housing.

13. The assembly according to claim 5, wherein said temperature sensor being electrically coupled to said control circuit, said control circuit receiving said temperature input when said temperature sensor senses that any of said female electrical contacts exceeds said pre-determined temperature.

14. The assembly according to claim 6, further comprising a test button being movably coupled to said power supply, said test button being electrically coupled to said control circuit, said contact relay being turned off when said test button being depressed.

15. The assembly according to claim 6, further comprising a light emitter being coupled to said power supply wherein said light emitter being configured to emit light outwardly therefrom, said light emitter being electrically coupled to said control circuit, said light emitter being turned on when said contact relay being actuated into said turn on condition wherein said light emitter being configured to visually communicate that each of a pair of female contacts has electrical current being supplied thereto.

16. A fire safety assembly for plugging into an electrical outlet and severing electrical service when heat or smoke being detected for inhibiting a fire from developing, said assembly comprising:
a power supply being pluggable into a female electrical outlet wherein said power supply being configured to receive electrical current from the female electrical outlet, said power supply comprising:
a housing having a rear wall, a front wall and an outer wall extending therebetween, said outer wall having a pair of vents extending into an interior of said housing on opposing sides of said housing wherein each vent is perpendicular to said rear wall and is thereby configured to be positioned perpendicular to the female electrical outlet to pass air into and through said housing;
a plurality of male contacts, each of said male contacts being coupled to and extending away from said rear wall of said housing, each of said male contacts being comprises of an electrically conductive material, each of said male contacts being pluggable into the female electrical outlet; and
a plurality of female contacts, each of said female contacts being recessed into said front wall of said housing wherein each of said female contacts being configured to receive a power cord of an electrical device;
a shut off circuit being integrated into said power supply, said shut off circuit turning off said power supply when said shut off circuit receives an alert input, said shut off circuit comprising:
a control circuit being integrated into said power supply, said control circuit being electrically coupled to each of said male contacts and each of said female contacts, said control circuit receiving a smoke input, said control circuit receiving a carbon monoxide input, said control circuit receiving a temperature input; and
a contact relay being positioned within said housing, said contact relay being electrically coupled to said control circuit, said contact relay being electrically coupled between each of said male contacts and each of said female contacts, said contact relay being actuated into a shut off condition when said control circuit receives any of said smoke input, said carbon monoxide input or said temperature input wherein said contact relay being configured to inhibit electrical current from passing between said male contacts and said female contacts, said contact relay being actuated into a turn on condition when said control circuit does not receive any of said smoke input, said carbon monoxide input or said temperature input wherein said contact relay being configured to pass electrical current between said male contacts and said female contacts;
a smoke detector being integrated into said power supply wherein said smoke detector being configured to detect smoke, said shut off circuit receiving said alert input when said smoke detector detects smoke wherein said power supply being configured to inhibit an electrical fire from starting, said smoke detector being in fluid communication with said vent in outer wall of said housing, said smoke detector being electrically coupled to said control circuit, said control circuit receiving said smoke input when said smoke detector detects smoke;
a carbon monoxide sensor being integrated into said power supply wherein said carbon monoxide sensor being configured to sense carbon monoxide, said shut off circuit receiving said alert input when said carbon monoxide sensor senses carbon monoxide wherein said power supply being configured to inhibit an electrical fire from starting, said carbon monoxide sensor being in fluid communication with said vent in said outer wall of said housing, said carbon monoxide sensor being electrically coupled to said control circuit, said control circuit receiving said carbon monoxide input when said carbon monoxide sensor senses carbon monoxide;
a temperature sensor being integrated into said power supply, said temperature sensor being in thermal communication with said power supply, said shut off circuit receiving said alert input when said temperature sensor senses that said power supply has exceeded a pre-determined temperature wherein said power supply being configured to inhibit an electrical fire from starting, said temperature sensor being in thermal communication with each of said female contacts in said housing, said temperature sensor being electrically coupled to said control circuit, said control circuit receiving said temperature input when said temperature sensor senses that any of said female electrical contacts exceeds said pre-determined temperature;
a test button being movably coupled to said power supply, said test button being electrically coupled to said control circuit, said contact relay being turned off when said test button being depressed; and
a light emitter being coupled to said power supply wherein said light emitter being configured to emit light outwardly therefrom, said light emitter being electrically coupled to said control circuit, said light emitter being turned on when said contact relay being actuated into said turn on condition wherein said light emitter being configured to visually communicate that each of said female contacts has electrical current being supplied thereto.
